(19) United States
(12) Patent Application Publication
(10) Pub. No.: US 2023/0339514 A1
(43) Pub. Date: Oct. 26, 2023

(54) METHOD FOR PREDICTING TRAFFIC PARTICIPANT BEHAVIOR, DRIVING SYSTEM AND VEHICLE

(71) Applicant: Continental Automotive Technologies GmbH, Hannover (DE)

(72) Inventor: Jörg Reichardt, Regensburg (DE)

(73) Assignee: Continental Automotive Technologies GmbH, Hannover (DE)

(21) Appl. No.: 18/307,602

(22) Filed: Apr. 26, 2023

(30) Foreign Application Priority Data
Apr. 26, 2022 (EP) 22169922.6

(51) Int. Cl. B60W 60/00; B60W 40/04

(52) U.S. Cl. CPC B60W 60/0027; B60W 40/04; B60W 2554/40

(57) ABSTRACT

A method is disclosed for predicting traffic participant behavior. The method includes obtaining a first kinematic state distribution of a traffic participant at a first time. Second kinematic state distributions of the traffic participant are projected at a second time which is a first time span into the future. A distribution of trajectories are defined, wherein each trajectory links a kinematic state of the first kinematic state distribution to a kinematic state of the second kinematic state distribution. A third kinematic state distribution is obtained of the traffic participant at a third time which is a second time span later than the first time and shorter than the first time span. Compatibilities between the third kinematic state distribution and a distribution of kinematic states resulting from evaluating each trajectory of the distribution of trajectories at the third time are determined and probabilities assigned to the trajectories using the determined compatibilities.

### CROSS-REFERENCE TO RELATED APPLICATIONS

The present application claims the benefit and priority of European Patent Application No. 22169922.6, filed on Apr. 26, 2022, the content of which is incorporated by reference herein.

### TECHNICAL FIELD

The invention relates to a method for predicting traffic participant behavior, to a driving system, in particular a driver assistance system and/or an autonomous driving system, configured to execute the method for predicting traffic participant behavior, and to a vehicle including the driving system.

### BACKGROUND

In order to provide safe and/or comfortable driving, driving systems such as driver assistance systems and/or autonomous driving systems need anticipatory planning. In this context, anticipatory means that the driving system is able to incorporate expectations about the future motion of dynamic agents, i.e., traffic participants, in the surroundings of the vehicle.

In general, the driving system does not have access to motion plans of the agents in the environment and the agents rarely actively signal their intents unequivocally. Hence, to predict the future behavior of the agents, the driving system has to make inferences based on past observations.

Simple extrapolations based on the kinematic states (position, velocity, acceleration) of the agents are typically valid only up to approximately 2 s into the future. However, longer predictions would be beneficial for the driving system.

Known trajectory prediction systems often make a prediction based on past observations only and new predictions are made without evaluating the past predictions in the light of whether they are supported by observations gathered since the prediction was made, i.e., they do not integrate with tracking algorithms.

Other known trajectory prediction systems generate the trajectory predictions forward in time from current observations. This leads to the accumulation of prediction errors, is computationally costly and often leads to dynamically unfeasible trajectories.

### SUMMARY

It is therefore an object of the present disclosure to provide an improved method for predicting traffic participant behavior, a corresponding driving system as well as a vehicle comprising such a driving system.

The object of the present disclosure is addressed by the subject-matter of the independent claims, wherein further embodiments are incorporated in the dependent claims.

According to a first aspect of the present disclosure, a method for predicting traffic participant behavior is provided. In this context, traffic may refer to land traffic and exemplary traffic participants are pedestrians, bicyclists, motorcycles, cars and trucks. Alternatively, or additionally, traffic may refer to air traffic, wherein exemplary traffic participants are planes, helicopters, air ships, hot-air balloons and drones, and/or to sea traffic, wherein exemplary traffic participants are ships. Further, in this context, behavior refers to the motion of the traffic participant, e.g., to its position, velocity and/or acceleration.

According to the method, a first kinematic state distribution of at least one traffic participant at a first time is obtained. Here, the first time may preferably be the current time or a time just before the current time, i.e., at most a second, or a fraction of a second before the current time. That is, the first kinematic state distribution is obtained in real time.

In particular, the first kinematic state distribution is a distribution of first kinematic state variables, wherein a probability density is assigned jointly to all first kinematic state variables.

Further, second kinematic state distributions of the at least one traffic participant are projected, wherein the kinematic state variables of the second kinematic state distributions are the kinematic state variables of the at least one traffic participant at a second time. The second time is a first time span into the future from the first time, i.e., the difference of the second time and the first time is the first time span. The second kinematic state distributions may be, for each traffic participant, continuous and/or disjoint distributions of kinematic state variables.

Then, a distribution of trajectories is defined, wherein each trajectory of the distribution of trajectories links a kinematic state of the first kinematic state distribution to a kinematic state of the second kinematic state distribution. That is, each trajectory is such that when the trajectory is evaluated at the first time, it has a kinematic state of the first kinematic state distribution, and when the trajectory is evaluated at the second time, it has a kinematic state of the second kinematic state distribution. Also, the intermediate kinematic states are given by the trajectory, i.e., both a path of the traffic participant and the motion along this path are given by the trajectory.

Further, a third kinematic state distribution of the at least one traffic participant is obtained, the third kinematic state distribution being the probability distribution of kinematic states at a third time. The third time is a second time span later than the first time, wherein the second time span is shorter than the first time span. In particular, the second time span is much shorter than the first time span. As an example, the second time span may correspond to the time between two consecutive determinations of the kinematic state distributions, i.e., the third kinematic state distribution is the next iteration of determined probabilities of kinematic states after the first kinematic state distribution. As another example, the second time span may be a fraction of a second, e.g., one tenth of a second or half a second, or even one second.

Then, the trajectories of the distribution of trajectories are evaluated at the third time, i.e., kinematic states are determined that correspond to the trajectories at the third time. Compatibilities between the third kinematic state distribution and the distribution of kinematic state variables resulting from evaluating the trajectories at the third time are determined. That is, it is determined whether or not the trajectories are compatible with the obtained third kinematic states, i.e., with which probability the third kinematic states lie on the trajectories.

Based on the determined compatibilities, probabilities are assigned to the trajectories of the distribution of trajectories, i.e., the probability distribution of the trajectories is updated. And since the trajectories correspond to the second kinematic states, the assignment of probabilities to the trajectories of the distribution of trajectories corresponds to an assignment of probabilities to the kinematic states of the second kinematic state distributions. The assignment of the probabilities may be performed as a likelihood computation in a Bayesian way. In particular, some trajectories and/or second kinematic states will be determined as being more likely and other trajectories and/or second kinematic states will be determined as being less likely.

Since the second kinematic state distribution is the only projection made and the remainder of the kinematic states is determined from the trajectories that correspond to the second kinematic states, a good computational efficiency is obtained by the method.

As different trajectories may correspond to different maneuvers, e.g., lane change or keep lane, estimating probabilities for different trajectories allows estimating maneuver probabilities with a solid statistical approach.

According to an embodiment, the kinematic state variables of the first, second and/or third kinematic state distribution comprise at least one out of a group, the group consisting of a position, a velocity, an acceleration and a jerk, wherein the jerk is the third temporal derivative of the position. It is understood that the choice out of the group does not necessarily have to be the same for the first, second and/or third kinematic state distribution; however, in an embodiment, each kinematic state of the first, second and third kinematic state distribution comprises the position, the velocity and the acceleration. Of course, the kinematic states of the first, second and/or third kinematic state distribution may also comprise even higher temporal derivatives of the position, however, these higher derivatives are increasingly difficult to obtain or the uncertainty in these higher derivatives is very large. For land and sea vehicles, it is often sufficient to restrict the kinematic states to two dimensions, i.e., to the horizontal plane. On the other hand, for air vehicles, the kinematic states should also include the vertical dimension.

According to an embodiment, the at least one traffic participant is an ego vehicle and/or at least one other traffic participant. In this context, vehicle may be any land, air or sea vehicle, and even a pedestrian with a smart device configured to execute the method may be referred to as “vehicle”. As an example, the method may be performed for all traffic participants that can be detected by sensors of the ego vehicle. As another example, the method may be performed for all traffic participants within a predetermined radius around the ego vehicle that can be detected by the sensors of the ego vehicle. Said predetermined radius may depend, e.g., on the velocity of the ego vehicle. As yet another example, the method may be performed for at most a predetermined number of traffic participants that are closest to the ego vehicle. And as yet another example, the method may be performed on all traffic participants that may come close to the ego vehicle by the second time.

According to an embodiment, the first kinematic state distribution and/or the third kinematic state distribution of the at least one traffic participant are obtained from tracking the at least one traffic participant. Here, the tracking is performed using sensors of the ego vehicle, such as cameras, lidar and/or radar. In particular, the tracking is performed with a multi-object multi-hypotheses tracker that keeps track of the identification of objects with observations. Of course, if the at least one traffic participant is the ego vehicle, the first and/or third kinematic state distribution may be determined, e.g., via measurements of the speedometer, measurements of a steering wheel angle, measurements taken by an inertial measurement unit, or the like. In this case, the first and/or third kinematic state distribution may be very narrow, with a width of the probability distribution corresponding to the uncertainty in the above mentioned measurements.

According to an embodiment, in the step of projecting the second kinematic state distribution, interactions of the at least one traffic participant with a static environment are accounted for. For this, the data pertaining to the static environment may be provided, e.g., from maps and/or from the vehicle sensors. As an example, possible second kinematic states for motor vehicles may be chosen only on roads and not on sidewalks, inside buildings (except for parking garages) or on meadows. The possible kinematic states of the second kinematic state distribution may be further restricted to the correct side of the road—unless passing is allowed and indicated, e.g., by a slower preceding vehicle—or according to further traffic rules. Further, the possible kinematic states of the second kinematic state distribution may be restricted to such states that result in a trajectory that has feasible kinematic properties, e.g., that does not exceed the top speed of the vehicle or that does not exceed possible accelerations of the vehicle. These rules often lead to several localized peaks in the second kinematic state distribution, which result in multi-modal distributions.

Additionally, or alternatively, the interaction of traffic participants with each other may be accounted for. Here, for example, it may be accounted for that the traffic participants avoid a crash. As another example, different behavior of one traffic participant may lead to a different situation for another traffic participant. As a specific example, if a slow preceding vehicle turns right at an intersection, there is no need to pass the vehicle when going straight. As another example, traffic rules call for different behavior at an intersection, depending on whether another traffic participant turns right, goes straight or turns left. When these rules are applied, there will be several localized peaks in the second kinematic state distribution for each traffic participant and, as indicated above, these peaks will depend on the second kinematic state distributions of other traffic participants. Hence, the resulting probability distributions are multi-object multi-modal distributions.

According to an embodiment, the first time span is between 3 s and 10 s, in particular approximately 5 s. Shorter first time spans would not provide much information beyond a simple kinematic extrapolation of the kinematic states. Longer time spans, however, cannot be reliably predicted since they provide time for several changes in the behavior of each traffic participant, and there is not enough evidence to accurately predict said changes. Further, a time span of 10 s, and even of 5 s, is usually sufficient to provide safe and comfortable driving.

According to an embodiment, the trajectories of the distribution of trajectories are given using a parametric trajectory representation. That is, the trajectories are not a set of points in the kinematic space but are given as a function of time, wherein the function of time depends on a number of parameters. Since each trajectory has to link a kinematic state of the first kinematic state distribution to a kinematic state of the second kinematic state distribution, the trajectory evaluated at the first time has to return the kinematic state of the first kinematic state distribution and the trajectory evaluated at the second time has to return the kinematic state of the second kinematic state distribution. Hence, the parameters for a trajectory have to be chosen such that these requirements are fulfilled. Unless there is some degeneracy and in order to provide a unique definition of the trajectory, the number of parameters has to equal the number of boundary values. As an example, if for each of the kinematic states of the first and second kinematic state distributions position, velocity and acceleration are given, there are three boundary values per space dimension from the kinematic state of the first kinematic state distribution and three boundary values per space dimension from the kinematic state of the second kinematic state distribution. Hence, there are a total of six boundary values per space dimension and for a unique definition of the trajectory, the number of parameters of the parametric representation has to be six times the number of space dimensions.

According to an embodiment, the trajectories are given as a linear combination of a predetermined number of basis functions. Hence, the parameters are the coefficients of each of the basis functions. In this case, it also suffices to evaluate the basis functions and their derivatives (first and second, if the kinematic states of the first and second kinematic state distributions include position, velocity and acceleration) once for the first time and once for the second time. Then, the problem of finding the parameters reduces to a simple linear equation system.

In particular, the predetermined number is between 5 and 8, most particularly 6 per space dimension. Five (5) basis functions per space dimension correspond, e.g., to the position, velocity and acceleration for the kinematic states of the first kinematic state distribution and the position and velocity for the kinematic states of the second kinematic state distribution. Six (6) basis functions per space dimension correspond, e.g., to the position, velocity and acceleration for the kinematic states of both the first and second kinematic state distributions. And 8 basis functions per space dimension correspond, e.g., to the position, velocity, acceleration and jerk for the kinematic states of both the first and second kinematic state distributions. In many cases, 6 basis functions per space dimension is the optimal trade-off between accuracy and available kinematic state data. Less than 5 basis functions per space dimension lead to a loss of accuracy and more than 8 basis functions per space dimension are usually not supported by the available kinematic state data.

According to an embodiment, the basis functions are monomials, i.e., the trajectories are given as x(t)=Σᵢ₌₀^{N-1}aᵢt¹, and similarly for the other space dimensions, wherein N is the number of basis functions and as are the coefficients. For many applications, this simple approach yields an excellent parametrization of the trajectory.

Alternatively, the basis functions are Bernstein polynomials, i.e.,

$${b}_{i , N} ( t ) = ( \begin{matrix}N \\ i\end{matrix} ) {{t}^{i} ( 1 - t )}^{N - i} .$$

Here, the first time and the second time have to be scaled such that for the first time, t=0, and for the second time, t=1. This approach makes parameter values particularly intuitive and interpretable.

According to an embodiment, the steps of determining compatibilities between the third kinematic state distribution and a distribution of kinematic state variables resulting from evaluating each of the trajectories of the distribution of trajectories at the third time and assigning probabilities to the trajectories of the distribution of trajectories based on the determined compatibilities are solved as follows.

First, a cost function is set up. This cost function depends on traffic participants xⱼat the first time, which are the traffic participants for which the first kinematic state distributions have been obtained, but may also encompass traffic participants xⱼ that have not yet been detected at the first time. Here, the index j equals the number of detected traffic participants at the first time plus a number of yet undetected traffic participants. The cost function also depends on future options o^{f}_{j,k_j} of the traffic participants xⱼ at the second time, wherein the future options are discrete options of the second kinematic state distributions. Finally, the cost function depends on the traffic participants oᵢ detected at the third time, i.e., the traffic participants for which the third kinematic state distributions have been obtained.

The cost function is then given as the negative log likelihood of the probability that an observation oᵢ is made for an object xⱼ that has the future option o^{f}_{j,k_j}:C_{ijk_j}=−ln P(oᵢ |xⱼ, o^{f}_{j,k_j}).

The data association problem related to this cost function would be to find the minimum

$${min}_{X} {\sum }_{ijk \_ j} {C}_{ijk \_ j} {X}_{ijk \_ j} ,$$

wherein the data association matrix X_{ijk_j} has the properties Σ_{jk_j}X_{ijk_j}=1 for all i and Σ_{ik_j}X_{ijk_j}≤1 for all j. In particular, the data association matrix only has the entries 0 and 1.

In order to solve the data association problem using the standard algorithms known from multi-object multi-hypotheses trackers, the cost function is minimized with respect to the discrete options of the second kinematic state distributions, i.e., with respect to k_j, to obtain the minimized cost function

$${C}_{ij}^{′} = {min}_{k \_ j} {C}_{ijk\_j} .$$

The options of the second kinematic state distributions that lead to each entry of the minimized cost function are given by

$${k}_{ij}^{′} = arg {min}_{k \_ j} {C}_{ijk \_ j} .$$

Assignments of objects to observations given the future options may then be given by a list of tuples (i, j, k_j).

Finally, standard multi-object multi-hypotheses tracker algorithms are applied to find the minimum or a predetermined number of (lowest) minima of the minimized cost function, i.e., the equation

$${min}_{X} {\sum }_{ij} {C}_{ij}^{′} {X}_{ij}$$

is solved, where X is once again a data association matrix with ΣⱼXᵢⱼ=1 for all i and ΣⱼXᵢⱼ23 1 for all j.

Since the efficient standard multi-object multi-hypotheses tracker algorithms are available, the computational cost of the minimization of the cost function is low compared to a direct solution of the original minimization problem

$${min}_{X} {\sum }_{ijk\_j} {C}_{ijk\_j} {X}_{ijk\_j} .$$

According to an embodiment, the method further includes predicting fourth kinematic state distributions of the at least one traffic participant. Here, the fourth kinematic state distributions include probability distributions of the kinematic states at a fourth time. In particular, the fourth time is between the third time and the second time, i.e., in the future, but bounded by the second time. The fourth kinematic state distributions are obtained from evaluating each of the trajectories of the distribution of trajectories at the fourth time, as already explained above. The probabilities for the kinematic states of the fourth kinematic state distributions are then determined through the probabilities given by the distribution of trajectories.

According to an embodiment, the predicted fourth kinematic state distributions are multi-modal distributions. This is, in particular, the case when the second kinematic state distributions are already multi-modal distributions, e.g., due to the requirements from the interactions with the static environment. In particular, the fourth kinematic state distributions are multi-object multi-modal distributions. This is, in particular, the case when the second kinematic state distributions are already multi-object multi-modal distributions, e.g., due to the requirements from the interactions with each other. It has to be noted that, in this case, the probabilities of these distributions are usually joint probabilities to which no factorization applies.

According to an embodiment, the method further includes controlling the ego vehicle based on the distribution of trajectories and/or based on the fourth kinematic state distributions. That is, the predicted trajectories of the ego vehicle and the other traffic participants are used to find the trajectories that lead to the safest, most comfortable, most efficient and/or fastest driving. Then, the ego vehicle is controlled—e.g., the speed and the direction is adjusted—such that it is moved along the corresponding trajectory for the ego vehicle. For this, the method provides a fast and reliable prediction of the trajectories.

According to a second aspect of the present disclosure, a driving system is provided. The driving system may be a driver assistance system and/or an autonomous driving system. The driving system is configured to execute the method according to the above description. Hence, in particular, the driving system predicts a distribution of trajectories of traffic participants and chooses the trajectory that provides the safest, most comfortable, most efficient and/or fastest driving for the ego vehicle.

According to a third aspect of the present disclosure, a vehicle including a driving system according to the above description is provided. Hence, the driving system of the vehicle provides the safest, most comfortable, most efficient and/or fastest driving for the ego vehicle.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a flowchart of a method for predicting traffic participant behavior;

FIG. 2 shows a flowchart of a method for controlling a vehicle based on predicted traffic participant behavior;

FIG. 3 shows a top view of an ego vehicle at an intersection; and

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DESCRIPTION OF EMBODIMENTS

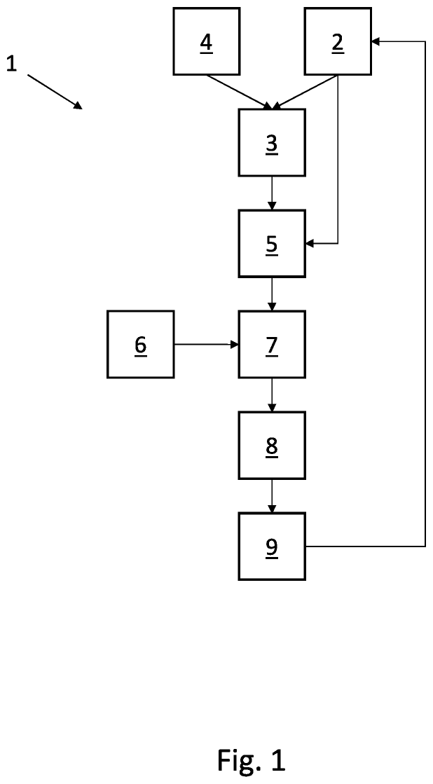

FIG. 1 shows a flowchart of a method 1 for predicting traffic participant behavior. In step 2 of the method, a first kinematic state distribution of at least one traffic participant at a first time is obtained. The kinematic states of the first kinematic state distribution may be at least one out of a position, velocity, acceleration or jerk. The at least one traffic participant may be an ego vehicle and/or another traffic participant. The traffic participants may be land vehicles such as pedestrians, bicyclists, motorcycles, cars and trucks, air vehicles such as planes, helicopters, air ships, hot-air balloons and drones, and/or sea vehicles such as ships. Obtaining the first kinematic state distribution may be performed using sensors of the ego vehicle, such as cameras, lidar and/or radar and tracking the at least one traffic participant, in particular with a multi-object multi-hypotheses tracker.

In step 3 of the method, second kinematic state distributions of the at least one traffic participant at a second time are projected. Here, the second time is a first time span into the future from the first time. The first time span may be between 3 s and 10 s, in particular around 5 s. The kinematic states of the projected second kinematic state distributions may also be referred to as pseudo-observations.

For the projection of the second kinematic state distributions, interactions of the at least one traffic participant with a static environment 4 are accounted for. That is, path options are generated based, e.g., on maps and/or on sensor readings. In particular, kinematic states within the second kinematic state distributions are excluded if they are not allowed.

Also, for the projection of the second kinematic state distributions, interactions with other traffic participants are taken into account, wherein the data for the other traffic participants comes from the first kinematic state distribution obtained in step 2.

Based on the first kinematic state distribution obtained in step 2 and the second kinematic state distributions projected in step 3, a distribution of trajectories, wherein each trajectory of the distribution of trajectories links a kinematic state of the first kinematic state distribution to a kinematic state of the second kinematic state distribution, is defined in step 5. The trajectories of the distribution of trajectories may, in particular, be given using a parametric trajectory representation, more particularly as a linear combination of a predetermined number of basis functions. If, for example, the kinematic states of the first and second kinematic state distributions each comprise a position, a velocity and an acceleration, there have to be six basis functions per spatial dimension such that the trajectory is uniquely defined.

Further, step 5 includes predicting a distribution of kinematic states resulting from evaluating each of the trajectories of the distribution of trajectories at a third time, wherein the third time is a second time span later than the first time and wherein the second time span is shorter than the first time span. Hence, the third time is between the first time and the second time. In step 5, in order to keep track of probabilities, a Kalman filter may be used.

In step 6, a third kinematic state distribution of the at least one traffic participant is obtained at the third time. This is performed similar to obtaining the first kinematic state distribution, in particular new observations from the sensors are evaluated.

In step 7, compatibilities between the third kinematic state distribution directly obtained in step 6 and the distribution of kinematic states at the third time obtained from the evaluation of the distribution of trajectories in step 5 are determined. In particular, a data association cost matrix is set-up and the corresponding data association problem is solved.

With the solution of the data association problem, a Kalman update step for a trajectory tracker is performed in step 8. Then, the probabilities of the distribution of trajectories is updated in step 9, wherein in particular a list of a predetermined number M of most likely kinematic states in the first kinematic state distribution as well as of most likely kinematic states in the third kinematic state distribution is updated. Hence, a prediction of the traffic participant behavior has been made.

The updated probabilities of step 9 may then be used again as input for step 2.

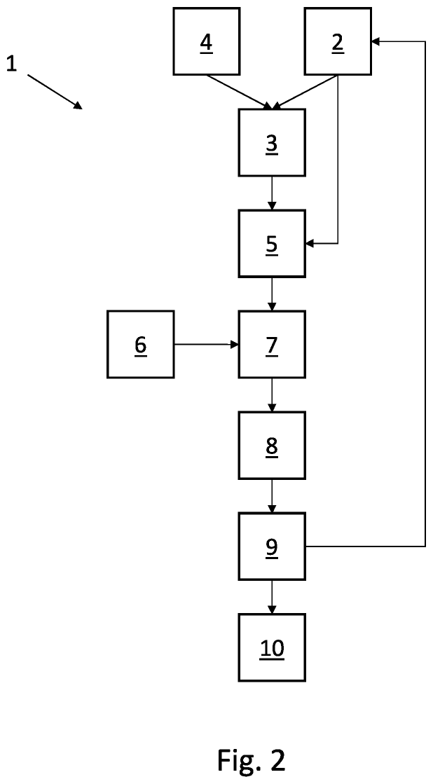

FIG. 2 shows a flowchart of a method 1 for controlling a vehicle based on predicted traffic participant behavior. The steps 2 to 9 of this method are identical to the method 1 for predicting traffic participant behavior. However, the results of step 9 are used as input for a driving system, in particular a driver assistance system and/or an autonomous driving system, for controlling the ego vehicle in step 10.

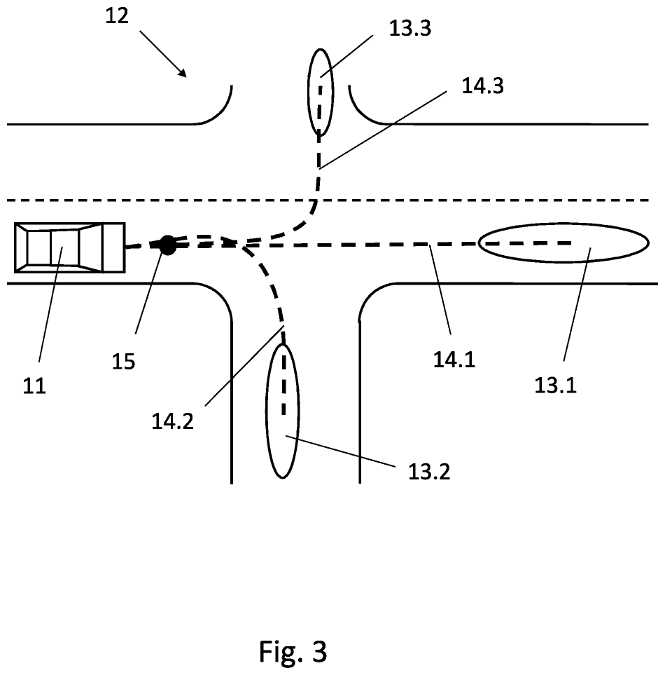

As an example, FIG. 3 shows a top view of an ego vehicle 11 at an intersection 12. Second kinematic state distributions 13 of the ego vehicle 11 include three discrete options 13.1, 13.2 and 13.3, wherein the first option 13.1 corresponds to the vehicle going straight, the second option 13.2 corresponds to the vehicle turning right and the third option 13.3 corresponds to the vehicle turning left. For each of these discrete options 13.1, 13.2 and 13.3, trajectories 14.1, 14.2 and 14.3, respectively, are shown that link the current position of the ego vehicle, i.e., a first kinematic state, to the kinematic states of the second kinematic state distributions.

When a third kinematic state distribution 15 is obtained at a later time, the compatibility of the third kinematic state distribution 15 with the trajectories 14 evaluated at the later time may be used to predict the future behavior of the ego vehicle.

When more than one traffic participant is involved, i.e., at least one traffic participant other than the ego vehicle, the second kinematic state distributions of the vehicles depend on one another and probabilities of different discrete options do, in general, not factorize.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

### LIST OF REFERENCE SIGNS

1 method for predicting traffic participant behavior
2 obtaining a first kinematic state distribution
3 projecting a second kinematic state distribution
4 static environment
5 defining a distribution of trajectories
6 obtaining a third kinematic state distribution
7 determining compatibilities
8 updating a trajectory tracker
9 updating distribution of trajectories
10 controlling an ego vehicle
11 ego vehicle
12 intersection
13 second kinematic state distributions
13.1-13.3 first to third option
14 distribution of trajectories
14.1-14.3 first to third option
15 third kinematic state distribution

1. Method for predicting traffic participant behavior, comprising:
obtaining a first kinematic state distribution of at least one traffic participant at a first time;
projecting second kinematic state distributions of the at least one traffic participant at a second time, the second time being a first time span into the future from the first time;
defining a distribution of trajectories, wherein each trajectory of the distribution of trajectories links a kinematic state of the first kinematic state distribution to a kinematic state of the second kinematic state distribution;
obtaining a third kinematic state distribution of the at least one traffic participant at a third time, the third time being a second time span later than the first time, wherein the second time span is shorter than the first time span;
determining compatibilities between the third kinematic state distribution and a distribution of kinematic states resulting from evaluating each of the trajectories of the distribution of trajectories at the third time; and
assigning probabilities to the trajectories of the distribution of trajectories based on the determined compatibilities.

2. Method according to claim 1, wherein the kinematic states of at least one of the first, second or third kinematic state distribution comprise at least one out of a group, the group consisting of a position, a velocity, an acceleration and a jerk.

3. Method according to claim 1, wherein the at least one traffic participant is at least one of an ego vehicle or at least one other traffic participant.

4. Method according to claim 1, wherein at least one of the first kinematic state distribution or the third kinematic state distribution of the at least one traffic participant are obtained from tracking the at least one traffic participant.

5. Method according to claim 1, wherein in projecting the second kinematic state distribution, interactions of the at least one traffic participant with at least one of a static environment or each other are accounted for.

6. Method according to claims 1, wherein the first time span is between 3 s and 10 s.

7. Method according to claim 1, wherein the trajectories of the distribution of trajectories are given using a parametric trajectory representation.

8. Method according to claim 7, wherein the trajectories of the distribution of trajectories are given as a linear combination of a predetermined number of basis functions.

9. Method according to claim 8, wherein the basis functions are monomials or Bernstein polynomials.

10. Method according to claim 1, wherein determining the compatibilities between the third kinematic state distribution and the distribution of kinematic states resulting from evaluating each of the trajectories of the distribution of trajectories at the third time, and assigning the probabilities to the trajectories of the distribution of trajectories based on the determined compatibilities comprise:
setting up a cost function;
minimizing the cost function with respect to discrete options of the second kinematic state distributions; and
applying standard multi-object multi-hypotheses tracker algorithms to find at least one of the minimum or a minima of the minimized cost function.

11. Method according to claim 1, the method further comprising:
predicting fourth kinematic state distributions of the at least one traffic participant at a fourth time, the fourth time being, in particular, between the third time and the second time, wherein kinematic states of the fourth kinematic state distribution are obtained from evaluating each trajectory of the distribution of trajectories at the fourth time, using the probabilities of the trajectories given by the distribution of trajectories.

12. Method according to claim 11, wherein the predicted fourth kinematic state distributions are multi-modal distributions.

13. Method according to claim 1, the method further comprising:
controlling the ego vehicle based on at least one of the distribution of trajectories or the predicted fourth kinematic state distributions.

14. Driving system, in particular driver assistance system and/or autonomous driving system, configured to execute the method according to claim 13.

15. Vehicle comprising a driving system according to claim 14.

16. Method according to claim 4, wherein the at least one traffic participant is tracked with a multi-object multi-hypotheses tracker.

17. Method according to claim 6, wherein the first time span is about five seconds.

18. Method according to claim 8, wherein the predetermined number is between five and eight.

19. Method according to claim 11, wherein the multi-modal distributions comprise multi object multi modal distributions.
